(19) United States
(12) Patent Application Publication
(10) Pub. No.: US 2007/0170701 A1
(43) Pub. Date: Jul. 26, 2007

(54) Trailer having removably attachable wheel assemblies

(76) Inventor: Serge Dugal, Quebec (CA)

Correspondence Address: Louis Tessier, C.P. 54029, Mount-Royal, QC, H3P 3H4, US

(21) Appl. No.: 11/698,087

(22) Filed: Jan. 26, 2007

Related U.S. Application Data
(60) Provisional application No. 60/762,134, filed on Jan. 26, 2006.

(51) Int. Cl. B62B 5/00

(52) U.S. Cl. 280/656

(57) ABSTRACT

A trailer for moving a load, the trailer including a main supporting component for supporting the load, the main supporting component defining a reference plane extending thereacross. The trailer also includes a pair of wheel assemblies. Each of the wheel assemblies includes a wheel; a wheel support removably attachable to the main supporting component; and an axle rotatably mounting the wheel to the wheel support. When the wheel supports are attached to the main supporting component, the wheels are in a substantially parallel relationship relatively to each other; each supported in a cantilevered configuration by a respective one of the wheel supports, the wheels being substantially perpendicular to the reference plane; and each supported in a substantially spaced apart relationship relatively to the main supporting component in a direction substantially perpendicular to the reference plane.

This application claims priority from U.S. Provisional Patent Application Ser. No. 60/762,134 filed Jan. 26, 2006.

### FIELD OF THE INVENTION

The present invention relates to the general field of trailers, and is particularly concerned with a trailer, such as for example a boat trailer, towable by all-terrain vehicles and the like.

### BACKGROUND OF THE INVENTION

There exists a longstanding trend towards increased popularity of outdoor activities. In the practice of such outdoor activities, it is often found enjoyable to use relatively small boats, such as boats of the pram or so-called “car top” type. Sportsman and recreational boat users are hence often confronted with the desire for a convenient apparatus to transport a boat from place to place.

For example, it may be desirable to transport a relatively small boat from an automotive parking area to the water and returning it. Since small recreational boats are typically 8 to 20 feet long, and relatively heavy, they often present a serious portage problem, particularly in rugged terrain.

On the other hand, ATVs (all-terrain vehicles) are now widely used by campers and other outdoor enthusiasts to travel across a wide variety of terrains, including relatively rugged terrain, and to get into otherwise relatively inaccessible backwoods areas. For example, such ATVs are conventionally used to get into backwoods areas that are inaccessible to other less mobile outdoor enthusiasts.

It is thus highly desirable to provide a boat trailer usable for carrying a conventional boat, the boat trailer being adapted to be towed by a conventional all-terrain vehicle.

In addition, to ease their transportation to a site at which they are to be used, it is desireable that such boat trailers be easily disassembled into a compact configuration. This objective causes many design problems as the trailers need to have a relatively good structural integrity while being easily assembled in a small amount of time. Since structural integrity is typically achieved in conventional trailers by adding material to the trailer, such trailers are typically not suitable for boat carrying as this additional material typically causes problems in compactness for storage in a disassembled configuration and compactness when assembled and assembled and pulled through narrow spaces, such as tracks employed by ATVs in forests.

Against this background, there exists a need in the industry to provide novel trailers.

An object of the present invention is therefore to provide such an improved trailer.

### SUMMARY OF THE INVENTION

In accordance with the present invention, there is provided a trailer for moving a load, the trailer including a main supporting component for supporting the load, the main supporting component defining a reference plane extending thereacross. The trailer also includes a pair of wheel assemblies. Each of the wheel assemblies includes a wheel; a wheel support removably attachable to the main supporting component; and an axle rotatably mounting the wheel to the wheel support. When the wheel supports are attached to the main supporting component, the wheels are in a substantially parallel relationship relatively to each other; each supported in a cantilevered configuration by a respective one of the wheel supports, the wheels being substantially perpendicular to the reference plane; and each supported in a substantially spaced apart relationship relatively to the main supporting component in a direction substantially perpendicular to the reference plane.

In accordance with the present invention, there is also provided a boat trailer for carrying a boat, the boat having a haul defining a haul rear end and a longitudinally opposed haul front end, the haul also defining a substantially horizontal haul main section for receiving a boat load and maintaining the boat load afloat, and a substantially angled haul front section for facilitating the hydrodynamic forward movement of the boat, the haul front section being angled by a main-to-front section angle relative to the haul main section, the boat trailer being attachable to a towing vehicle having a towing vehicle hitch; the boat trailer comprising: a main boat supporting component for contacting the haul main section substantially adjacent to the haul rear end; a pair of wheels attachable to the main boat supporting component by a wheel-to-supporting component attachment means extending therebetween for rollably supporting the main boat supporting component; an attachment arm extending from the main boat supporting component for attaching the boat trailer to the vehicle hitch, the attachment arm being provided with an arm length adjustment means for allowing adjustment of the length thereof; an auxiliary boat supporting component for contacting the haul main section substantially adjacent the haul front section, the auxiliary boat supporting component being attachable to the attachment arm at selective locations therealong; whereby the boat trailer allows for independent selective adjustment of both the length of the attachment arm and the positioning of the auxiliary boat supporting component therealong.

Typically, the attachment arm includes a vehicle attachment; an arm main segment extending from the main boat supporting component; an arm auxiliary segment extending from the arm-to-hitch attachment means substantially towards the arm main spacing segment; an arm spacing segment extending between the arm main and auxiliary segments for providing a vertical spacing between the arm main and auxiliary segments; the arm auxiliary segment defining an auxiliary segment length, the ratio between the vertical spacing and the auxiliary segment length having a value of approximately ¼.

Conveniently, each of the wheels is rotatably secured to the main boat supporting component by a corresponding wheel to plate attachment rod, the wheel-to-supporting component attachment means being of structural components other than the main boat supporting component extending between the attachment rods underneath the main boat supporting component.

In accordance with the present invention, there is also provided a boat trailer for carrying a boat, the boat having a haul defining a haul rear end and a longitudinally opposed haul front end, the haul also defining a substantially horizontal whole haul main section for receiving a boat load and maintaining the boat load afloat, and a substantially angled haul front section for facilitating the hydrodynamic forward movement of the boat, the haul front section being angled by a main-to-front section angle relative to the haul main section, the boat trailer being attachable to a towing vehicle having a towing vehicle hitch; the boat trailer comprising: a main boat supporting component for contacting the haul main section substantially adjacent to the haul rear end; a pair of wheels attachable to the main boat supporting component by a wheel-to-supporting component attachment means extending therebetween for rollably supporting the main boat supporting component; an attachment arm extending from the main boat supporting component for attaching the boat trailer to the vehicle hitch, the attachment arm including an arm-to-hitch attachment means; an arm main horizontal spacing segment extending from the main boat supporting component; an arm auxiliary segment extending from the arm-to-hitch attachment means substantially towards the arm main spacing segment; an arm vertical spacing segment extending between the arm main and auxiliary spacing segments for providing a vertical spacing between the arm, main and auxiliary spacing segments; the arm auxiliary segment defining an auxiliary spacing segment length, the ratio between the vertical spacing and the auxiliary spacing segments length having a value of approximately ¼.

In accordance with the present invention, there is further provided a boat trailer for carrying a boat, the boat having a haul defining a haul rear end and a longitudinally opposed haul front end, the haul also defining a substantially horizontal whole haul main section for receiving a boat load and maintaining the boat load afloat, and a substantially angled haul front section for facilitating the hydrodynamic forward movement of the boat, the haul front section being angled by a main-to-front section angle relative to the haul main section, the boat trailer being attachable to a towing vehicle having a towing vehicle hitch; the boat trailer comprising: a main boat supporting component for contacting the haul main section substantially adjacent to the haul rear end; an attachment arm extending from the main boat supporting component for attaching the boat trailer to the vehicle hitch; a pair of wheels attachable to the main boat supporting component by wheel-to-supporting component attachment means extending therebetween for rollably supporting the main boat supporting component; each of the wheels being rotatably secured to the main boat supporting component by a corresponding wheel to plate attachment rod, the wheel-to-supporting component attachment means being deprived of structural components other than the main boat supporting component extending between the attachment rods underneath the main boat supporting component.

Advantages of the present invention include that the proposed trailer is customizable in configuration and shape so as to accommodate a wide variety of boats. More specifically, the proposed trailer is customizable so as to allow boats having various lengths and/or haul configurations to be carried thereon.

Also, the proposed trailer is designed so as to be customizable for use in transporting other types of loads, such as gear, equipment, boat accessories and the like. The proposed trailer may hence also be used as a so-called utility trailer, or for any other suitable purpose.

Furthermore, the proposed trailer is designed so as to be readily attachable to a wide variety of towing vehicles and particularly to a wide variety of conventional all-terrain vehicles, or the like. More particularly, the proposed trailer is designed so as to attachable to conventional towing vehicle attachments, such as conventional hitch balls or the like, through a set of quick and ergonomical steps, without requiring special tooling or manual dexterity.

Still furthermore, customization of the trailer configuration for receiving boats of various configurations and sizes and/or for attachment to towing vehicles of various configurations and sizes is typically accomplished in a quick and easy manner, again through a set of ergonomical steps, without requiring strength, dexterity or special tooling.

The proposed trailer is specifically designed for taking into consideration a relatively long bumper-to-hitch ball distance associated with conventional ATVs while still providing a relatively high degree of manoeuvrability, even in relatively confined environments. Also, the proposed trailer is designed so as to provide a trailer-load combination having a relatively low center of gravity so as to prevent the risks of having the load, and/or the trailer, tip over in relatively uneven and rugged terrain.

Yet still furthermore, the proposed trailer is designed so as to minimize the risk of interference between components thereof and environmental elements, such as tree stumps, branches, rocks and the like, so as to reduce the risks of the trailer being jammed or otherwise prevented from being towed on terrain having obstacles thereon.

The proposed trailer is further designed so as to enable its intended user to easily load a boat thereon without the physical straining of high lifting. The proposed trailer is designed so as to allow mounting thereon of conventional canoes, rowboats, small boats or other water recreational vehicles with reduced risk of damaging the latter, and without the need for altering the latter, so as to allow safe mounting thereof.

The proposed trailer is specifically designed so as to be of rugged construction allowing it to go virtually anywhere an ATV can be manoeuvred while carrying a relatively heavy load without it being damaged. Yet still furthermore, the proposed trailer is designed so as to be easily assembled and disassembled into relatively compact components so as to reduce the area for storage and/or transportation thereof when not in use, while allowing quick assembly thereof when needed.

Yet still furthermore, the proposed trailer is designed so as to be manufacturable using conventional forms of manufacturing and conventional components so as to provide a trailer that will be economically feasible, long-lasting and relatively trouble-free in operation.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1: in a top perspective view, illustrates an ATV boat trailer in accordance with an embodiment of the present invention;

FIG. 2: in a partial exploded view, illustrates the ATV boat trailer shown in FIG. 1;

FIG. 3: in a top perspective view, illustrates a main boat supporting component part of the ATV boat trailer shown in FIGS. 1 and 2;

FIG. 4: in a perspective bottom view with sections taken out, illustrates the main boat supporting component shown in FIG. 3;

FIG. 5: in a top perspective view with sections taken out, illustrates a portion of an attachment arm part of a boat trailer shown in FIGS. 1 through 4;

FIG. 6: in a top perspective view, illustrates another section of an attachment arm part of a boat trailer shown in FIGS. 1 through 4;

FIG. 7: in a bottom perspective view, illustrates an auxiliary boat supporting component part of an ATV boat trailer in accordance with an embodiment of the present invention;

FIG. 8: in a top perspective view, illustrates the auxiliary boat supporting component shown in FIG. 7;

FIG. 9: in a top perspective view, illustrates an auxiliary boat supporting component in accordance with an alternative embodiment of the invention;

FIG. 10: in a bottom perspective view, illustrates the auxiliary boat supporting component shown in FIG. 9;

FIG. 11: in a partial perspective view with sections taken out, illustrates a wheel-to-supporting component attachment structure part of an ATV boat trailer in accordance with an embodiment of the present invention;

FIG. 12: in an exploded view, illustrates the wheel-to-supporting component attachment structure shown in FIG. 11;

FIG. 13: in a partial bottom perspective view, illustrates the wheel-to-supporting component attachment structure shown in FIGS. 11 and 12 mounted to a main supporting component both part of an ATV boat trailer in accordance with an embodiment of the present invention;

FIG. 14: in a bottom perspective view, illustrates an initial step for assembling an ATV boat trailer in accordance with an embodiment of the present invention;

FIG. 15: in a bottom perspective view, illustrates a second step for assembling an ATV boat trailer in accordance with an embodiment of the present invention;

FIG. 16: in a top perspective view, illustrates a third step for assembling an ATV boat trailer in accordance with an embodiment of the present invention;

FIG. 17: in a top perspective view, illustrates a fourth step for assembling an ATV boat trailer in accordance with an embodiment of the present invention;

FIG. 18: in a top perspective view, illustrates an assembled ATV boat trailer in accordance with an embodiment of the present invention; and

FIG. 19: in a side elvation view, illustrates an assembled ATV boat trailer in accordance with an embodiment of the present invention.

### DETAILED DESCRIPTION

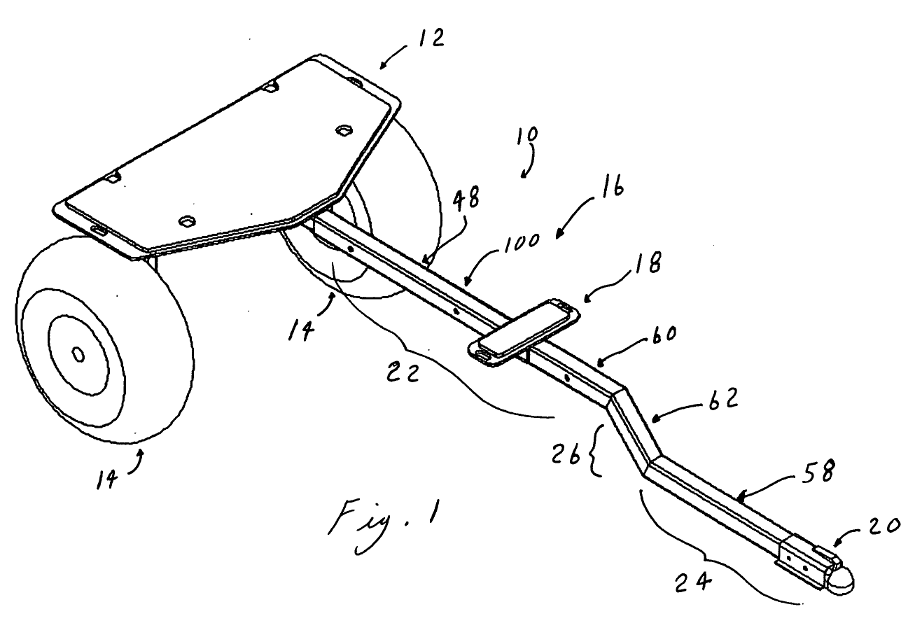

Referring to FIG. 1, there is shown a trailer for moving a load in the form of an ATV boat trailer in accordance with an embodiment of the present invention generally designated by the reference numeral 10. The trailer 10 is intended to be used for carrying a boat (not shown) having a hull defining a hull rearward end and a longitudinally opposed hull front end. However, in alternative embodiments of the invention, a trailer similar to the trailer 10 is usable to carry or move any other suitable load.

The hull typically defines a hull main section for receiving a boat load and maintaining the boat load float. The hull also defines a substantially angled hull front section for facilitating the hydrodynamic forward movement of the boat on a surface of water. Typically, the hull front section is angled by a main-to-front section angle relative to the hull main section.

The present invention is intended to be used for carrying boats having various types of hull configurations. For example, the present invention is intended to carry boats having hull main and angled sections of various lengths. The trailer 10 is also intended to carry boats having main-to-front section angles of various values. Furthermore, the trailer 10 may optionally be used for carrying other types of loads, such as outboard motors for the boats, various types of gears or equipment and the like, without departing from the scope of the present invention.

The trailer 10 is adapted to be attached to a suitable towing vehicle, such as a conventional all-terrain vehicle (not shown). One of the characteristics of conventional all-terrain vehicles resides in that the hitch ball extending therefrom is typically located substantially adjacent to the ground surface. Furthermore, with conventional all-terrain vehicles there exists a relatively long bumper-to-hitch ball distance, which is taken into consideration in the design of the trailer 10. It should however be understood that the trailer 10 could be used with other suitable types of vehicles without departing from the scope of the present invention.

The trailer 10 includes a main supporting component for supporting a load in the form of a main boat supporting component 12 for contacting the hull main section, typically substantially adjacent to the hull rear end thereof. The trailer 10 also includes a pair of wheels 14 attachable to the main boat supporting component 12 by a wheel-to-supporting component attachment extending therebetween. The wheels 14 are intended to rollably support the main boat supporting component 12 on a ground surface.

The main supporting component is substantially planar and defines a reference plane extending thereacross. In the embodiment of the invention shown in the drawings, the reference plane is parallel to the main boat supporting component 12.

The trailer 10 further includes an attachment arm 16 extending from the main boat supporting component 12 for attaching the boat trailer 10 to a suitable vehicle hitch through a vehicle attachment located substantially opposed to the main boat supporting component 12. Typically, but by no means exclusively, the attachment arm 16 is provided with a length adjustment mechanism for selectively adjusting a length of the attachment arm 16. Typically, the length adjustment mechanism is a telescopic-type length adjustment mechanism, although other types of length adjustment means could be used without departing from the scope of the present invention.

In some embodiments of the invention, the boat trailer is further provided with an auxiliary supporting component in the form of an auxiliary boat supporting component 18 for contacting the hull main section substantially adjacent to the hull front end thereof. The auxiliary boat supporting component 18 is attachable to the attachment arm 16 at selective longitudinally spaced apart locations therealong. Therefore, the auxiliary boat supporting component 18 is movable substantially longitudinally relatively to the attachment arm 16.

In a preferred embodiment of the invention, the boat trailer 10 allows for independent selective adjustment of both the length of the adjustment arm 16 and the positioning of the auxiliary boat supporting component 18 therealong. This allows for customization of the boat trailer 10 in order to accommodate not only boats of various hull or overall length, but also boats having various main-to-front section angular values.

The attachment arm 16 typically includes a vehicle attachment in the form of an arm-to-hitch attachment. The arm-to-hitch attachment may take any suitable form, such as that of an arm-to-hitch attachment socket 20 for attachment to a conventional hitch ball.

The attachment arm 16 also includes an arm main segment 22 extending from the main boat supporting component 12 and an arm auxiliary segment 24 extending from the arm-to-hitch attachment means substantially towards the arm main spacing segment 22. The attachment arm 16 further includes an arm spacing segment 26 extending between the arm main and auxiliary segments 22, 24 for providing a vertical spacing between the arm main and auxiliary segments 22, 24. The arm auxiliary segment 24 extends in a substantially spaced apart and parallel relationship relatively to the arm main segment 22 and is spaced apart from the arm main segment 22 in a direction leading substantially towards the wheels 14 by a spacing distance.

The arm auxiliary segment 24 defines an auxiliary segment length. Typically, the ratio between the auxiliary segment length and the spacing distance has a value of about 0.25. However, in other embodiments of the invention, the ratio between the spacing distance and the auxiliary segment length has any other suitable value, for example a value between about 0.15 and about 0.5.

The ratio between the auxiliary spacing segment length and the vertical spacing allows the trailer 10 to take advantage of the relatively low height of conventional ATV hitch balls, while allowing suitable clearance for allowing pivotal movement between conventional ATVs and the trailer 10 despite the relatively long spacing between the ball hitch and the rearwardmost component, or bumper, of conventional ATVs.

In some embodiments of the invention, as seen in FIG. 19, stability to the loaded trailer 10 and attached ATV is brought by having a spacing distance that is substantially similar to a distance between the center of the wheels 14 and the main supporting component 12, which minimizes torques exerted between the ATV and the trailer 10 due to relative motions therebetween caused by irregularities in the terrain over which the trailer 10 is pulled.

In some embodiments of the invention, the arm spacing segment 26 is angled at about 45 degrees relatively to the arm main segment 22 to maximize the structural rigidity of the attachment arm 12 using a minimal amount of material while keeping the trailer 10 easily manufacturable.

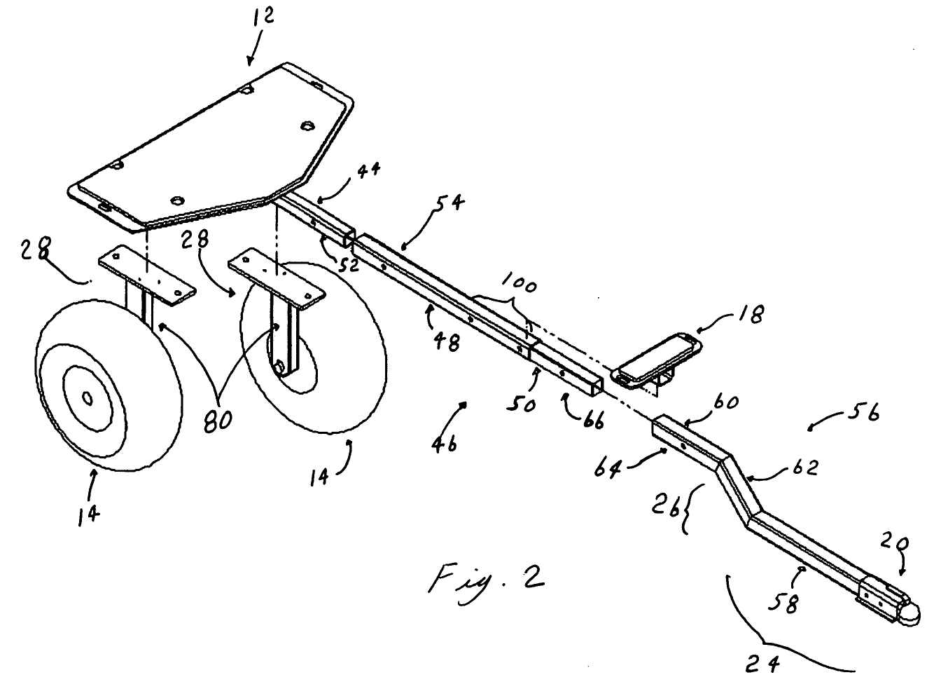

As shown more specifically in FIG. 2, each wheel 14 is rotatably secured to the main boat supporting component 12 by a corresponding a wheel support removably attachable to the main boat supporting component 12, the wheel support taking the form of a wheel-to-plate attachment component 28. The wheel-to-supporting component attachment is deprived of components, or structures, other than the wheel-to-plate attachment components 28 underneath the main boat supporting component 12. The trailer 10 hence provides an interference-free wheel-to-supporting component attachment means allowing the trailer 10 to be used in areas having obstacles, such as tree stumps, large rocks or the like, allowing such obstacles to pass underneath the boat main supporting component 12 without jamming or otherwise contacting the trailer 10.

When the wheel supports are attached to the main boat supporting component 12, the wheels 14 are in a substantially parallel relationship relatively to each other; each supported in a cantilevered configuration by a respective one of the wheel supports, the wheels being substantially perpendicular to the reference plane; and each supported in a substantially spaced apart relationship relatively to the main supporting component in a direction substantially perpendicular to the reference plane. It was found that this configuration allows for relatively easy storage of the disassembled trailer 10 while keeping a trailer 10 of minimal width.

With reference to FIG. 3, the main boat supporting component 12 typically includes a generally flat main plate. The configuration of the main plate is typically optimized so as to provide optimal support without unduly increasing the overall weight of the trailer 10. Typically, the main plate includes a substantially rectilinear main plate first end edge 30 located substantially opposite the attachment arm 16, the main plate first end edge 30 extending in a direction substantially perpendicular to the trailer longitudinal axis, and a pair of main plate lateral edges 32 extending substantially perpendicularly from the main plate first end edge 30 towards the attachment arm 16. The main plate also includes a main plate second end edge 34, extending in a substantially parallel and spaced relationship relative to the main plate first end edge 30, and a pair of main plate angled edges 36 each tapering from a corresponding main plate side edge 32 towards the main plate second end edge 34.

The main plate is typically made out substantially rigid materials, such as W50 grade steel. Typically, although by no means exclusively, the main plate has a size of approximately 36 inches by 18 inches and a thickness of approximately ¼ of an inch.

As seen in FIG. 19, the main plate defines substantially opposed main plate first and second surfaces 31 and 33. The main plate second surface 33 faces the wheels 14 and the main plate first surface 31 is a boat supporting surface. The boat supporting surface of the main plate is typically coated, or otherwise provided with a cushioning and/or friction enhancing layer 38 of suitable materials such as an elastomeric resin or the like. Returning to FIG. 3, the main plate is typically provided with main plate attachment apertures 40 extending therethrough and strategically positioned for receiving suitable fastening components used for fastening the wheel-to-plate attachment components 28 thereto.

Furthermore, the main plate is typically also provided with hook attachment apertures 42 extending therethrough for receiving attachment hooks part of bender-type components (not shown) typically used for releasably attaching the boat (also not shown) to the main plate. The hook attachment apertures 42 typically have a substantially slot-like configuration and an overall dimension of approximately one inch by one inch and ¾.

A plate arm segment 44 is solidly anchored to the main plate so as to protrude frontwardly from the latter. Typically, although by no means exclusively, the plate arm segment 44 is welded to the undersurface of the main plate 12. The plate arm segment 44 is intended to be used both as a means of connecting the attachment arm 16 to the main boat supporting component 12, and as a handling means for facilitating handling of the main boat supporting component 12 when the latter is disassembled from the other components part of the trailer 10.

Typically, although by no means exclusively, the plate arm segment 44 is a hollow tube made of suitable material, such as steel, having a substantially square cross-sectional configuration. For example, the plate arm segment 44 typically has a 1½ by 1½ inch cross-sectional configuration and a thickness substantially in the range of 3/16 of an inch. Also, typically, the plate arm segment 44 has a length substantially in the range of 20 inches.

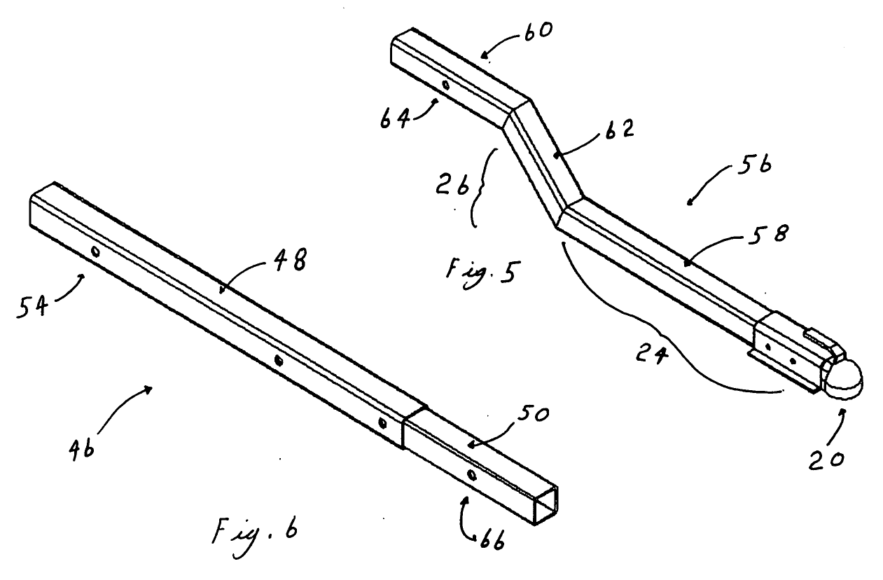

Referring now more specifically to FIG. 6, there is shown an optional arm extension segment 46 selectively insertable between the main boat supporting component 12 and the arm spacing segment 26 for selectively lengthening the attachment arm 16. The arm extension segment 46 together with the plate arm segment 44 are adapted to form the arm main segment 22. The horizontal spacing component 46 is typically optional and used mainly in situations wherein the length of the water recreational vehicle carried by the trailer 10 exceeds a predetermined length.

Typically, the arm extension segment 46 includes a first spacing tubing 48 and a second spacing tubing 50. The first spacing 48 is typically made out of a generally rigid material, such as steel, and typically has a substantially square cross-sectional configuration. Typically, although by no means exclusively, the first spacing tubing 48 has a 2 inches by 2 inches cross-sectional dimension, and a thickness substantially in the range of 3/16 of an inch.

The second spacing tubing 50 is inserted at least partially, and typically halfway, within the first spacing tubing 48. The second spacing tubing 50 typically has a corresponding square cross-sectional configuration and a cross-sectional dimensional area of 1½ inch by 1½ inch, and a thickness substantially in the range of 3/16 of an inch.

The length of the overall arm extension segment 46 is typically in the range of 38 inches, while the length of the second spacing tubing 50 is typically in the range of 20 inches. The second spacing tubing 50 is typically solidly attached to the first spacing tubing 48 using suitable means, such as weld lines.

The hollow end of the first spacing tubing 48 opposite to the second spacing tubing 50 is configured and sized for substantially fittingly and slidably receiving the protruding segment of the plate arm segment 44. The plate arm segment 44 and the first spacing tubing 48 are provided respectively with plate and spacing tubing attachment apertures 52, 54 adapted to be put in register with each other so as to receive an attachment pin (not shown) during assembly of the trailer 10.

Insertion of the plate arm segment 44 and the second spacing tubing 50 into the first spacing tubing 48 reinforces the latter while optimizing the overall weight of the arm main segment 22.

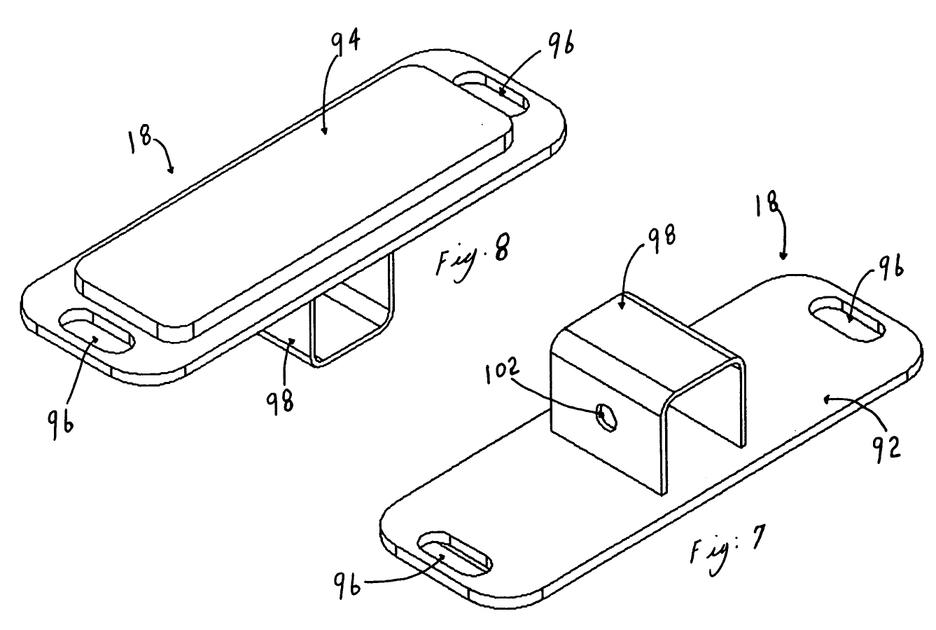

Referring now more specifically to FIGS. 7 and 8, there is shown some of the features of the auxiliary boat supporting component 18. The auxiliary boat supporting component 18 typically includes an auxiliary supporting plate 92. The embodiment shown in FIGS. 7 and 8, the auxiliary supporting plate 92 has a substantially rectangular configuration with dimensional values substantially in the range of 16 inches by 9 inches, and a thickness of approximately ¼ of an inch. The auxiliary supporting plate 92 is made out of a suitable resistant material, such as grade W50 steel.

The auxiliary supporting plate 92 is typically provided with a friction enhancing and cushioning means 94 mounted over a supporting surface thereof for optimizing the contact with the recreational water vehicle mounted thereon. Typically, the friction enhancing and cushioning means 94 includes a layer of suitable material, such as an elastomeric resin. The auxiliary supporting plate 92 is provided with auxiliary attachment apertures 96, typically having a generally slot-like configuration for receiving hooks part of standard components (not shown) used for attaching the water recreational vehicle thereto.

The auxiliary boat supporting component 18 is further provided with an auxiliary attachment sleeve 98 solidly anchored to an undersurface of the auxiliary attachment plate 92. The auxiliary attachment sleeve 98 typically has a generally square cross-sectional configuration and dimensional values in the range of 2¼ inch by 2¼ inch, with a thickness substantially in the range of 3/16 of an inch, and a length substantially in the range of 3 inches.

As illustrated more specifically in FIGS. 1 and 2, the auxiliary attachment sleeve 98 is configured and sized so as to be slidably and substantially fittingly inserted over the arm main segment 22. The auxiliary sleeve attachment apertures 102 (only one of which is shown in FIG. 7) extend through the auxiliary attachment sleeve 98. The auxiliary sleeve attachment apertures 102 are adapted to be put in register with corresponding auxiliary arm attachment apertures 100, or even the arm attachment aperture 66 for receiving a releasable attachment pin (not shown) so as to secure the auxiliary boat supporting components 18 at selective locations along the length of the arm main segment 22. Therefore, the length of the attachment arm 16 and the longitudinal position of the auxiliary boat supporting component 18 relatively to the attachment arm 12 are jointly fixable using a single locking component engaging both the auxiliary boat supporting component 18 and the length adjustment mechanism of the attachment arm 12.q

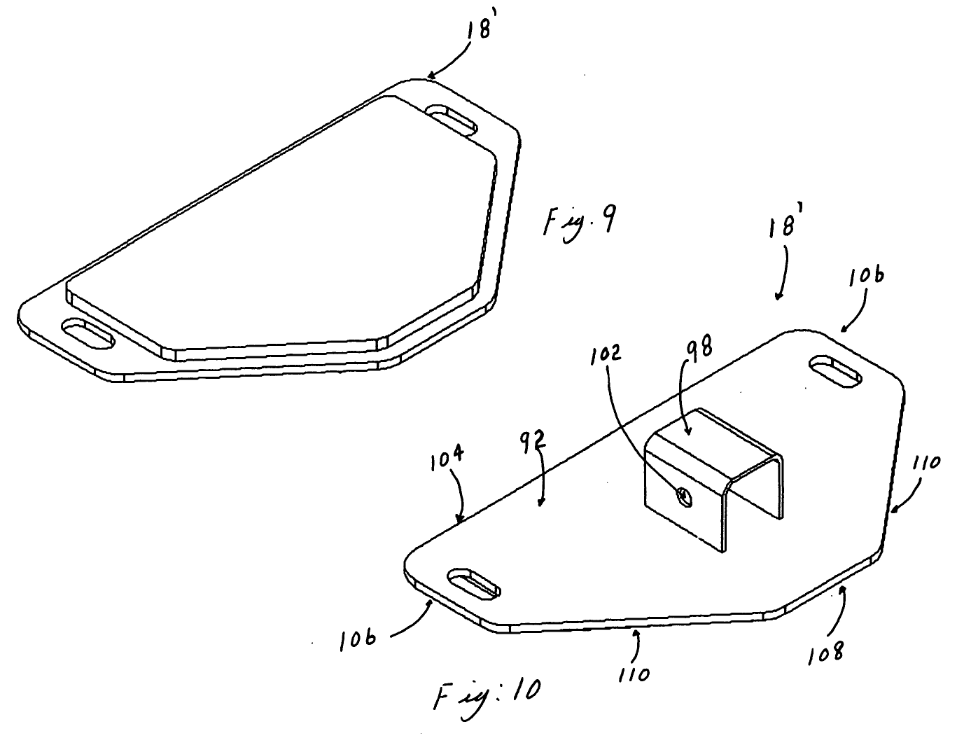

Referring now more specifically to FIGS. 9 and 10, there is shown an auxiliary boat supporting component 18′ in accordance with an alternative embodiment—Auxiliary boat supporting components 18′ is intended to be used mainly for supporting larger or heavier water recreational vehicles. The auxiliary boat supporting component 18′ is substantially similar to the auxiliary boat supporting component 18 and, hence, similar reference numerals will be used to denote similar components. Also, for similar reasons, the auxiliary boat supporting component 18 is shaped substantially similarly to the main boat supporting component 12.

One of the main differences between the auxiliary boat supporting components 18 and 18′ resides in the configuration of the auxiliary supporting plate 92. While the auxiliary supporting plate 92 of the auxiliary boat supporting component 18 has a generally rectangular, cross-sectional configuration with rounded corners, the auxiliary supporting plate 92 of the auxiliary boat supporting component 18′ defines auxiliary plate rear edge 104, a pair of auxiliary plate side edges 106 standing substantially perpendicularly from the auxiliary supporting plate rear edge 104 and an auxiliary plate front edge 108 extending in a spaced and substantially parallel relationship relative to the auxiliary plate rear edge 104.

The auxiliary supporting plate 92 also defines a pair of angled auxiliary plate edges 110 tapering from corresponding auxiliary plate side edges 106 towards the auxiliary plate front edge 108. The configuration of the auxiliary supporting plate 92 part of the auxiliary boat supporting component 18′ provides an optimized supporting capacity/weight ratio.

Referring now more specifically to FIG. 5, there is shown a hitch attachment arm component 56. The hitch attachment arm component 56 typically includes both the arm auxiliary segment 24 and the arm vertical spacing segment 26. The hitch arm component 56 also includes part of the arm main segment 22. The hitch arm component 56 includes a hitch arm first segment 58, a hitch arm second segment 60 and a hitch arm third segment 62 extending at an angle therebetween.

The hitch arm component 56 typically has a generally hollow and square cross-sectional configuration with dimensional values of approximately 2 inch by 2 inches, and a thickness substantially in the range of 3/16 of an inch. The hitch arm first segment 58 typically has a length substantially in the length of 23 inches. The hitch arm second segment 60 typically has a length substantially in the range of 13 inches.

The longitudinal ends of the hitch arm third segment 62 are typically cut at an angle of approximately 22̂4 degrees for fittingly mating with corresponding adjacent longitudinal segments of both the hitch arm first and second segments 58, 60. The hitch arm first, second and third segments 58, 60 and 62 are solidly attached together using suitable attachment means, such as weld lines or the like.

The hitch arm second segment 60 is adapted to substantially fittingly receive either the second spacing tubing 50 or the tubing segment of the plate arm component 44 depending on whether or not the spacing component 46 is used. The hitch second arm segment 60 is provided with a second arm segment attachment aperture 64 adapted to be put in register with either the attachment aperture 52 or a second spacing tubing attachment aperture 66 for fittingly receiving an attachment pin (not shown).

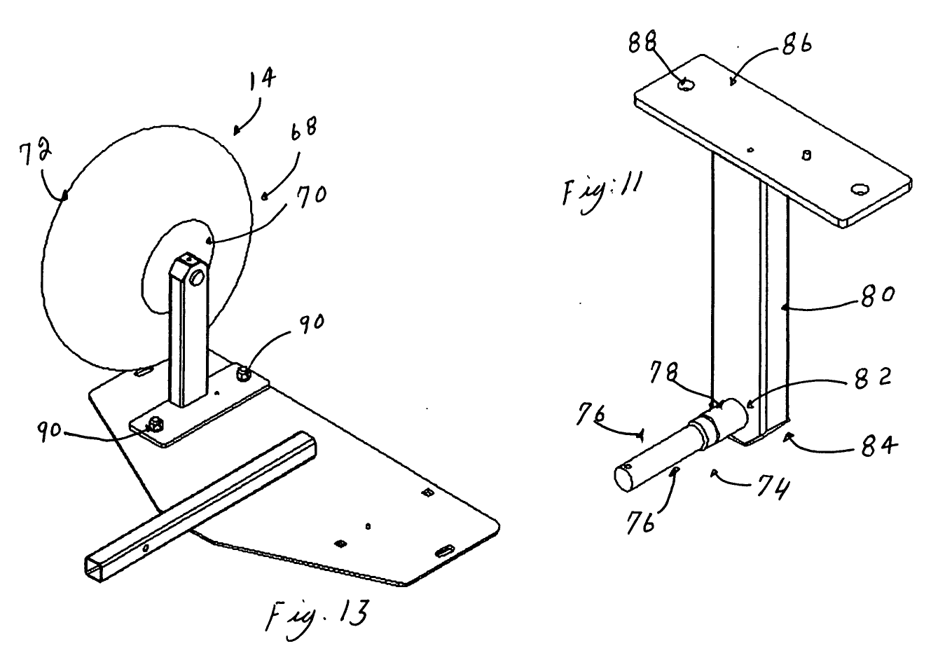

Referring now more specifically to FIGS. 11 through 13, there is shown in greater detail some of the features of the wheels 14 and wheel-to-plate attachment components 28. Each wheel 14 typically includes a corresponding tire 68 mounted over a tire rim 70.

The tire 68 and associated tire rim 70 may be of any suitable type although in a preferred embodiment of the invention, the tire 68 and the associated tire rim 70 is of the type typically used with conventional ATVs. Such tires 68 may be inflated with air at relatively low pressures, typically in the range of 2-4 PSI. Such tires 68 and associated tire rims 70 are adapted to act as a suspension means for the trailer 10.

The tire rim 70 typically includes suitable friction reducing means, such as conventional commercial bearing components. The tire rim 70 is provided with a rim aperture 72 extending therethrough for rollably and substantially fittingly receiving the rim section 76 of a shaft 74. The shaft 74 also defines an opposed shaft attachment segment 78.

A wheel arm 80 is provided for spacing the wheel 14 from the main boat supporting component 12. The wheel arm 80 is typically made out of a suitable resistant material, such as steel, and typically has a generally rectangular cross-sectional configuration with dimensional values substantially in the range of 1½ inch, and a thickness substantially in the range of 3/16 of an inch.

A lower segment of the wheel arm 80 is provided with a shaft receiving aperture 82 extending there through for receiving the attachment segment 78 of the shaft 74. Typically, the shaft attachment segment 78 is welded to the wheel arm 80 on opposite faces thereof, as well as within the wheel arm 80.

The wheel arm 80 is typically further provided with a generally V-shaped deflecting plate 84 mounted at a lower end thereof for allowing smooth sliding of the wheel arm 80 over various obstacles.

The wheel attachment plate 86 is welded or otherwise solidly attached to an upper segment of the wheel arm 80 and extends typically substantially perpendicularly thereto. The wheel attachment plate 86 is made out of a suitable material such as steel and typically has a generally rectangular configuration with dimensional values in the range of 4 inches by 12 inches, and a thickness substantially in the range of ⅜ of an inch.

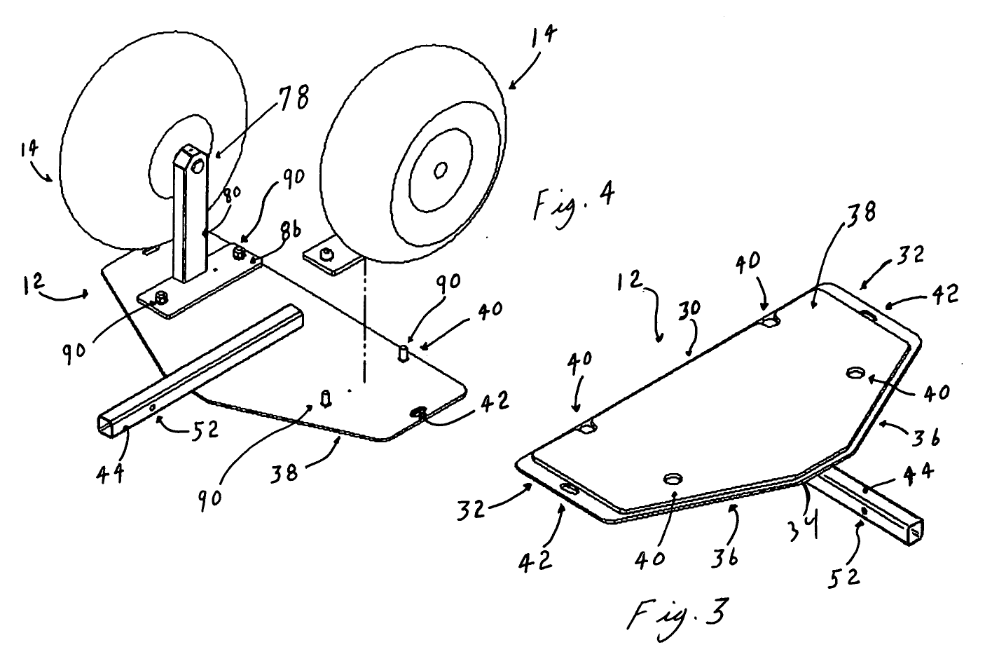

The wheel attachment plate 86 is provided with corresponding wheel attachment apertures 88 extending therethrough. The wheel attachment apertures 88 are adapted to be positioned substantially in register with the attachment apertures 40 of the main boat supporting component 12, as illustrated in FIG. 4.

Conventional releasable fastening components, such as bolts 90, are adapted to be inserted through the apertures 40, 88, releasably securing the wheel attachment plate 86 to the main boat supporting component 12. Typically, although by no means exclusively, the bolts 90 are graded bolts (CB-1.5) having dimensional values of 1½ inch by ⅝ of an inch.

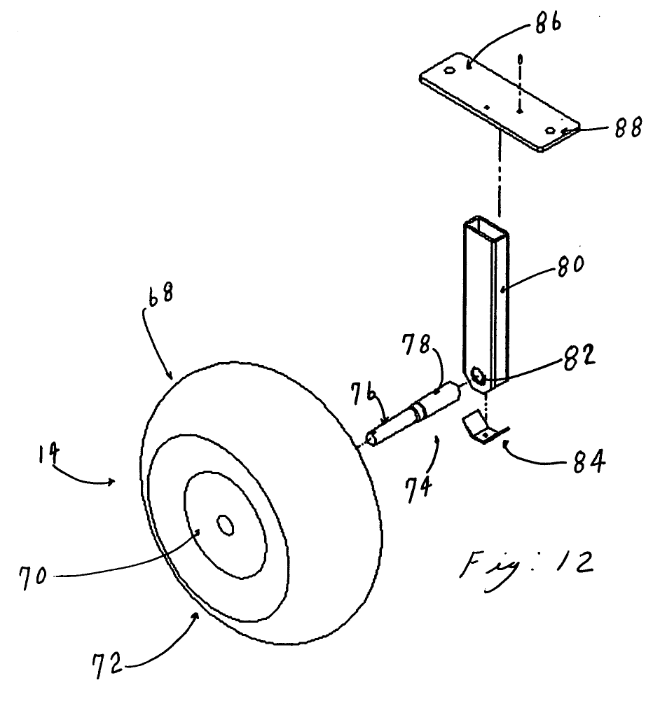

Referring now more specifically to FIGS. 14 through 18, there is shown some of the steps for assembling a trailer 10, in accordance with an embodiment of the present invention. FIG. 14 illustrates an initial step wherein a first wheel-to-plate attachment component 28 is secured to the main bolt supporting component 12 using bolts 90. FIG. 15 illustrates a second step wherein the other wheel-to-plate attachment component is also secured to the main bolt supporting component 12, again using bolts 90.

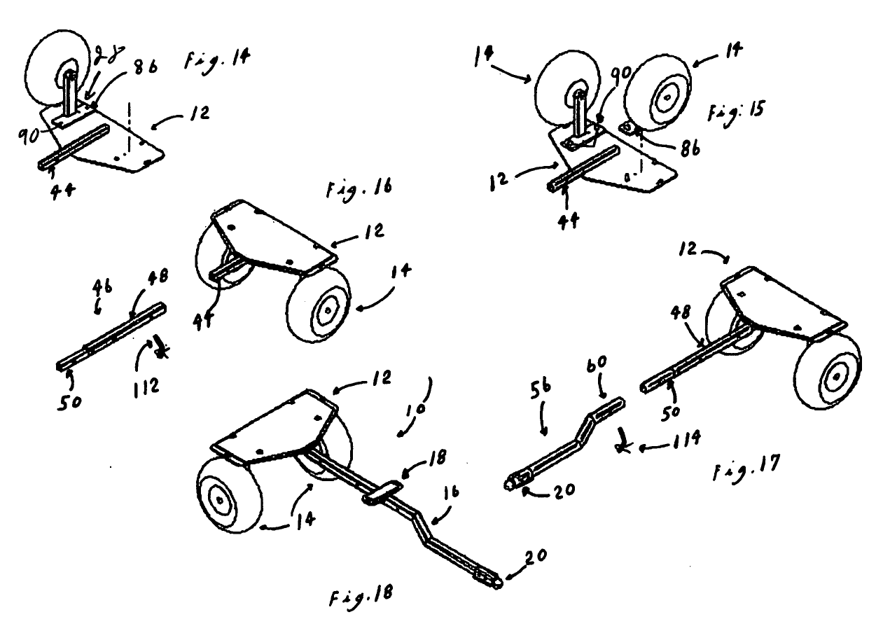

FIG. 16 illustrates a second spacing tubing 50 may be slidably and telescopically inserted into the first spacing tubing 48 so as to allow adjustment of the length of the spacing component 46 using suitable length adjustment apertures extending through both the first and second spacing tubings 48, 50 and corresponding length adjustment pins (not shown) for releasably securing the first and second spacing tubings 48, 50 in a predetermined longitudinal relationship relative to each other.

FIG. 16 illustrates also a third step wherein the horizontal spacing component 46 is secured to the plate arm segment 44 using a suitable attachment pin 112. FIG. 17 illustrates a fourth assembly step wherein the hitch arm segment 56 is attached to the horizontal spacing component 46 using a suitable attachment pin 114.

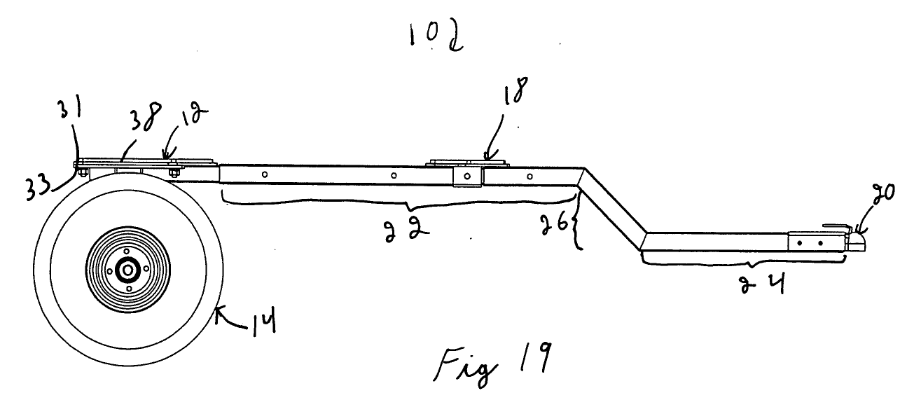

FIG. 18 illustrates the assembled trailer 10, the auxiliary boat supporting component 18 having been inserted over the arm 16 at a suitable location therealong prior to assembly of the component 56 to the component 46 simply using the same attachment pin 114, or another suitable attachment pin (not shown). The trailer 10 may be disassembled using reversed operational steps.

Although the present invention has been described hereinabove by way of preferred embodiments thereof, it can be modified, without departing from the spirit and nature of the subject invention as defined in the appended claims.

What is claimed is:

1. A trailer for moving a load, said trailer comprising:
a main supporting component for supporting said load, said main supporting component defining a reference plane extending thereacross; and
a pair of wheel assemblies, each of said wheel assemblies including
a wheel;
a wheel support removably attachable to said main supporting component; and
an axle rotatably mounting said wheel to said wheel support;
wherein when said wheel supports are attached to said main supporting component, said wheels are
in a substantially parallel relationship relatively to each other;
each supported in a cantilevered configuration by a respective one of said wheel supports, said wheels being substantially perpendicular to said reference plane; and
each supported in a substantially spaced apart relationship relatively to said main supporting component in a direction substantially perpendicular to said reference plane.

2. A trailer as defined in claim 1, wherein said trailer is attachable to a vehicle, said trailer further comprising an attachment arm extending from said main supporting component, said attachment arm including a vehicle attachment located substantially opposed to said main supporting component for attaching said attachment arm to said vehicle, said attachment arm including
an arm main segment extending from said main supporting component;
an arm auxiliary segment extending in a substantially spaced apart and parallel relationship relatively to said arm main segment, said arm auxiliary segment being spaced apart from said arm main segment in a direction leading substantially towards said wheels by a spacing distance; and
an arm spacing segment extending between said arm main and auxiliary segments.

3. A trailer as defined in claim 2, wherein said spacing distance is substantially similar to a distance between said axles and said main supporting component.

4. A trailer as defined in claim 2, wherein
said arm auxiliary segment defines an auxiliary segment length; and
a ratio between said spacing distance and said auxiliary segment length is between about 0.15 and about 0.5.

5. A trailer as defined in claim 4, wherein said ratio between said spacing distance and said auxiliary segment length is about 0.25.

6. A trailer as defined in claim 4, wherein said arm spacing segment is angled at about 45 degrees relatively to said arm main segment

7. A trailer as defined in claim 2, further comprising an arm extension segment selectively insertable between said main supporting component and said arm spacing segment for selectively lengthening said attachment arm.

8. A trailer as defined in claim 1, wherein said trailer is attachable to a vehicle, said trailer further comprising an attachment arm extending from said main supporting component, said attachment arm including a vehicle attachment located substantially opposed to said main supporting component for attaching said attachment arm to said vehicle, said attachment arm including a length adjustment mechanism for selectively adjusting a length of said attachment arm.

9. A trailer as defined in claim 8, wherein said attachment arm includes a telescopic-type length adjustment mechanism for selectively adjusting said length of said attachment arm.

10. A trailer as defined in claim 8, further comprising an auxiliary supporting component for supporting said load, said auxiliary supporting component being attachable to said attachment arm and movable substantially longitudinally relatively thereto.

11. A trailer as defined in claim 10, wherein said auxiliary supporting component is attachable to said attachment arm at selective longitudinally spaced apart locations therealong.

12. A trailer as defined in claim 10, wherein said length of said attachment arm and a longitudinal position of said auxiliary supporting component relatively to said attachment arm are selectively adjustable independently from each other.

13. A trailer as defined in claim 12, wherein said length of said attachment arm and said longitudinal position of said auxiliary supporting component relatively to said attachment arm are jointly fixable using a single locking component engaging both said auxiliary supporting component and said length adjustment mechanism.

14. A trailer as defined in claim 1, wherein said trailer is deprived of any structure, other than said main supporting component, extending between said wheel supports when said wheel supports are attached to said main supporting component.

15. A trailer as defined in claim 1, wherein said main supporting component includes a main plate, said main plate defining
a substantially rectilinear main plate first end edge located substantially opposite said attachment arm;
a pair of main plate lateral edges extending substantially perpendicularly from said main plate first end edge towards said attachment arm;
a pair of main plate angled edges each extending from a corresponding main plate side edge towards said attachment arm, said main plate angled edges being tapered in a direction leading away from said main plate first end edge; and
a main plate second end edge extending between said main plate angled edges.

16. A trailer as defined in claim 15, wherein
said main plate defines substantially opposed main plate first and second surfaces;
said main plate second surface faces said wheel assemblies; and
said main plate first surface is provided with at least one of a cushioning layer and a friction-enhancing layer.

17. A trailer as defined in claim 15, wherein said main plate is provided with hook attachment apertures extending therethrough for receiving attachment hooks part of bender-type components.

18. A trailer as defined in claim 1, wherein said wheel supporting components each include
a wheel arm for spacing said wheel from said main supporting component, said wheel arm defining substantially longitudinally opposed arm first and second ends, said wheel axle being attached to said wheel arm substantially adjacent said arm first end; and
a wheel attachment plate extending substantially perpendicularly from said wheel arm substantially adjacent said arm second end, said wheel attachment plate being removably attachable to said main supporting component.
